(19) United States
(12) Patent Application Publication
(10) Pub. No.: US 2002/0077833 A1
(43) Pub. Date: Jun. 20, 2002

(54) Transcription and reporting system

(76) Inventors: Barry M. Arons, Mountain View, CA (US); Jeremy Belldina, Burlingame, CA (US); Matthew T. Marx, Mountain View, CA (US); Atty Mullins, Santa FE, NM (US); Haleh Partovi, Hillsborough, CA (US); Orion A. Reblitz Richardson, Mountain Viwe, CA (US)

Correspondence Address: TELLME, C/O BEVER, HOFFMAN & HARMS, LLP, 2099 GATEWAY PLACE, SUITE 320, SAN JOSE, CA, 95110-1017, US

(21) Appl. No.: 09/747,026

(22) Filed: Dec. 20, 2000

(51) Int. Cl. G10L 21/00

(52) U.S. Cl. 704/277

(57) ABSTRACT

A web-based transcription and reporting system allows quick transcription of large numbers of utterances and provides reports on the transcription data in logical reports with linked access to underlying data. The system includes time-saving transcription aids such as buttons defining common noise events and anomalies. These transcription aids additionally may be accessed via keyboard shortcuts. Features of the web protocol are included in the transcription process. Reports are generated from the transcribed data meeting a set of reporting criteria. Reports are presented in one of a set of standard forms, wherein all standard forms include drill-down linking to increasingly detailed levels of supporting data.

### BACKGROUND OF THE INVENTION

1. Field of the Invention

The present invention relates to transcription and reporting, and specifically to a web-based transcription and reporting tool for use with voice applications.

2. Discussion of the Related Art

Telephones are ubiquitous in marketplaces around the world. Therefore, many attempts have been made to use the telephone to facilitate electronic commerce. Recent developments in telephone electronic commerce include the use of voice information to guide a transaction between a customer and a voice system. Voice information includes commands spoken by a speaker (e.g. a telephone user), wherein the commands represent transactions between the speaker and the system. For example, commands spoken may include keywords that navigate a menu tree. The spoken commands, called utterances, are interpreted for the voice system by a speech recognizer. Correct interpretation of these utterances by the speech recognizer is key to the success of this method of electronic commerce.

In improving the automated interpretation of utterances, voice systems usually use some form of utterance transcription to improve the accuracy of the speech recognizer. Utterances (i.e. audio information) are converted to text information in a process known as transcription. Transcription of utterances allows analysis of the accuracy of the speech recognizer by comparing the result of the speech recognizer to the text information generated by the transcription process. Utterances are typically transcribed with labels, which provide additional information on the utterances. For example, an utterance may be labeled with the gender of a speaker. Different uses for utterances require different labeling schemes. Thus, labels are non-standard over different applications. For example, utterances recorded from a cellular telephone may require labels describing call signal quality.

Most transcription and labeling tasks are accomplished with specialized and/or proprietary tools. Such tools range from foot pedal controlled tape players used in conjunction with a typewriter, wherein a transcriptionist listens to the tape and types the results, to custom software that aids in capturing a particular linguistic labeling scheme. Many transcription processes are inefficient in aiding the transcriptionist for both labeling and transcription. For example, in a foot pedal controlled tape player process, a transcriptionist must manually type every utterance and label, thereby having a maximum transcription rate corresponding to the typing speed of the transcriptionist. Additionally, the labels and annotations required for the labeling scheme of the particular application must be remembered or available for reference.

Typically, custom software is developed for use with a particular operating system, such as the Macintosh OS, Unix, or Windows NT. The general applicability of such tools is limited by their narrow focus on a specific application, a specific proprietary architecture, or a particular operating system. Due to typically narrow design requirements, custom software is often difficult to extend to differing transcription applications. Moreover, changes to the content and appearance of reports, once initially defined by the custom software, may be limited. Additionally, the requirement of a particular operating system for the custom software limits the flexibility of the transcriptionist in using a particular operating system or associated hardware. Furthermore, some custom software may require on-site transcription, thereby limiting the workforce available for transcription.

There are many similar tools for transcription, labeling, and annotation in existence today. Choosing the right combination of tools for a particular application can be a complex decision restricting the later flexibility of the application.

Therefore, a need arises for a method of, and a system for, an efficient transcription process having flexible use requirements.

### SUMMARY OF THE INVENTION

In accordance with the present invention, a cross-platform transcription and reporting system allows quick transcription of large numbers of utterances and provides analysis of the transcription data in logical reports with linked access to underlying data. The system includes time-saving transcription aids such as buttons defining common noise events and anomalies, thereby allowing a single click to replace numerous typed characters. Labels that are typically consistent across related utterances are pre-defined for each successive related utterance (i.e. consistent labels are “sticky”), thereby obviating the need for the transcriptionist to re-label the related utterances. These transcription aids additionally may be accessed via keyboard shortcuts, thereby saving additional time by allowing a single or multi-key keystroke to replace maneuvering a pointer to click a button and preventing the removal of the transcriptionist's hands from the keys on the keyboard. The text entry box can be pre-loaded with the result of the speech recognizer. In this manner, if the result is correct, the transcriptionist can accept that result by merely hitting the enter key. Note that the text entry box permits only allowable characters, thereby reducing the chance of an incorrect transcription.

Features common to web tools such as browsers are taken advantage of in the transcription process, such as auto-completion of a portion of a typed word. Additionally, the use of a web-based system allows distributed transcription across multiple sites and multiple transcriptionists, thereby decreasing costs associated with transcription. For example, multiple transcriptionists, each working from a home location remote from a central database pre-transcribed information, may access the central database simultaneously.

Transcribed data are stored in tuples (data structures) along with relevant environment and parameter data. Environment data stored in the tuple includes the grammar-in-use for the utterance. Accordingly, the transcribed data may be compared to the grammar-in-use for in-grammar/out-of-grammar determinations. Additionally, either the audio file of the associated utterance or a pointer to the audio file of the associated utterance is stored in each tuple. Thus, each transcribed utterance may be associated with the original audio utterance.

Reports are generated from the tuples meeting a set of reporting criteria. Reports detail the analysis of a set of parameters of the speech recognizer. Reports are presented in one of a set of standard forms, wherein all standard forms include drill-down linking to increasingly detailed levels of supporting data. Because tuples include both the transcribed data and the grammar-in-use, analysis may be made on utterances both in-grammar and out-of-grammar. Accuracy analysis easily includes both mis-accepted results of the speech recognizer and mis-rejected results of the speech recognizer. This ease of generating detailed reports allows authors of a grammar to quickly determine potential grammar issues, such as too large a grammar, too narrow a range of grammar pronunciations, and insufficient limitation of possible utterances.

Links to supporting data within the reports allow a double check of the transcription process. For example, a given accuracy statistic, which provides links leading to the audio utterance, allows the audio utterance to be compared to the transcribed utterance. Consistently incorrect results of the speech recognizer indicate an area of training required for the speech recognizer.

### BRIEF DESCRIPTION OF THE DRAWINGS

FIG. 1 is a block diagram of an utterance storage system in accordance with one embodiment of the present invention.

FIG. 2 is a screen shot of a sign-in screen for a transcription system according to one embodiment of the present invention.

FIG. 3 is a screen shot of a per-call-labels screen according to one embodiment of the present invention.

FIG. 4A is a screen shot of a transcription screen according to one embodiment of the present invention.

FIG. 4B is another screen shot of the transcription screen of FIG. 4A according to one embodiment of the present invention.

FIG. 5 is a flow diagram of the transcription process according to one embodiment of the present invention.

FIG. 6 is a screen shot of a top-level drill-down report according to one embodiment of the present invention.

FIG. 7 is a screen shot of a first-level-down drill-down report according to one embodiment of the present invention.

FIG. 8 is a screen shot of a second-level-down drill-down report according to one embodiment of the present invention.

FIG. 9 is a screen shot of a third-level-down drill-down report according to one embodiment of the present invention.

Similar elements in the above Figures are labeled similarly.

### DETAILED DESCRIPTION OF THE DRAWINGS

In accordance with the present invention, a cross-platform transcription and reporting system provides ease of use and user access from multiple locations. Web-based transcription tools allow multiple transcriptionists to interface with the information database using a web browser. Transcription information is compiled in a variety of reports organized in a drill-down to detail fashion. Specifically, direct access is provided from top-level statistics to low-level detail through a series of hyperlinks. A hyperlink (link) is an element in a web page that, when clicked upon, provides access to another web page, typically by navigating the web browser to the other web page. Web-based transcription tools additionally allow the use of built-in browser features (e.g. the auto-complete function).

In a telephone-based speech recognition system, during a transaction, users are led through a series of voice menus to achieve a desired result. For example, a transaction may include the user choosing a first voice option from a main menu (e.g. information regarding “weather”), and a second voice option from a secondary menu (e.g. desired location of weather information is “San Jose, Calif.”). To increase the accuracy of the speech recognition system, each menu has an associated local grammar with a limited scope. A grammar defines the set of valid expressions that a user can say when interacting with the speech recognition system. For example, a local grammar for the main menu above may include the expressions “stock quotes”, “traffic”, and “weather”. A local grammar for the weather secondary menu may include the expressions “Chicago, Ill.”, “New York City, N.Y.”, and “San Jose, Calif.”. To limit the scope of the local grammar in the secondary menu, the expressions “stock quotes”, “traffic”, and “weather” from the local grammar in the primary menu are not valid expressions when interacting with the secondary menu. Thus, the main menu local grammar is not in use when interacting with the secondary menu. Note that menus may have multiple associated local grammars. For example, the secondary menu above may also have additional local grammars, such as a list of valid zip codes corresponding to the city/state pairs of the first local grammar.

Intrinsic grammars are also available for use with menus. Intrinsic grammars are grammars with widespread applicability. Some intrinsic grammars are always available and may be used at any time when interacting with menus. For example, a global commands intrinsic grammar may include the expressions “help”, “go back”, and “repeat”. In one embodiment, because these global commands are useful for all menus, the global commands intrinsic grammar is always available. Other intrinsic grammars, such as a telephone number grammar (recognizing strings of numbers), and a date/time grammar (recognizing days of the week, months, days, and years) are available for use with appropriate menus.

Utterances from a telephone-based speech recognition system are recorded and used to train the speech recognition system. Utterances are the sounds made by a user (speaker) of the speech recognition system. Recordings of these utterances (e.g. typically 1 to 5 seconds) are digitized and stored in a database or a file system hierarchy (database). This database consists of both the utterance recordings (utterances) and a log of information relating to those utterances (such as the time the utterance was made, the grammar then in use, the result of the speech recognizer, other parameters, and a pointer to the specific utterance recording). Each stored element may be described as a record tuple: a series of records, each record having multiple elements. In one embodiment, each record is listed in the form (date/time, grammar then in use, result, parameters, pointer to stored utterance recording). In one embodiment, the utterance recording replaces the pointer to stored utterance recording in the tuple.

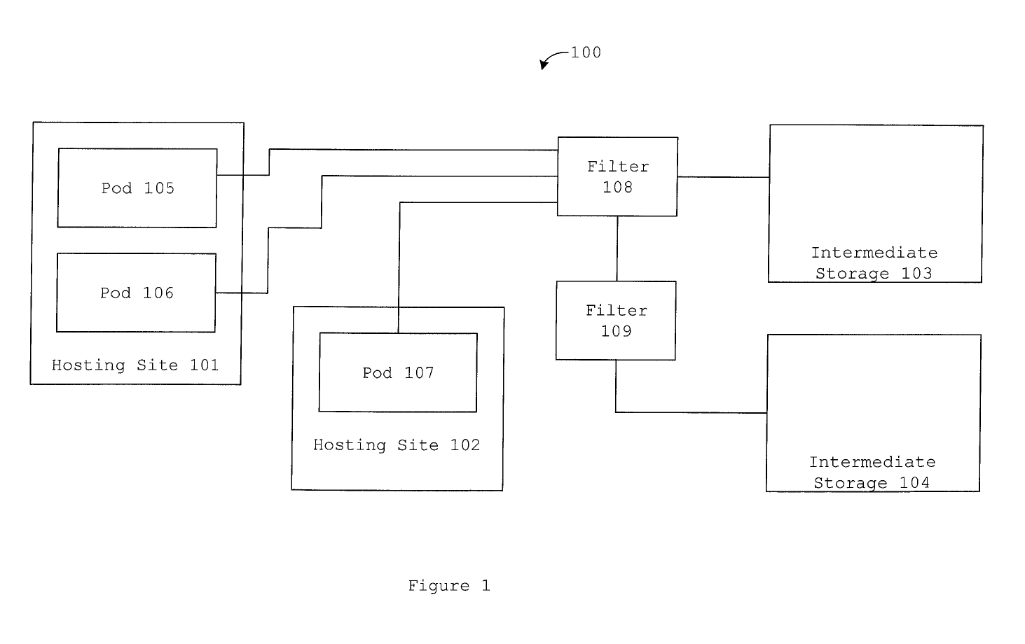

FIG. 1 is a block diagram of an utterance storage system 100 in accordance with one embodiment of the present invention. Storage system 100 includes hosting sites 101 and 102, which are physical locations housing storage equipment. Each hosting site includes one or more pods (e.g. hosting site 101 includes pods 105 and 106, and hosting site 102 includes pod 107). A pod is a collection of telephony speech recognition equipment coupled to phone lines. Each pod can handle a given number of simultaneous users (callers) interfacing with the speech recognition system. Thus, each pod creates utterance recordings from the user and generates a log file containing the associated record tuples.

Due to the volume of data (i.e. utterance recordings and the log file) stored in pods 105-107, selection criteria can be applied by filters 108 and 109 to aggregate the data from pods 105-107 into one or more tiers of intermediate storage 103 and 104. For example, in one embodiment, filter 108 applies selection criteria to the data in pods 105-107 to retrieve 50% of the data in pods 105-107 each evening and store that data in intermediate storage 103. In this embodiment, filter 109 applies selection criteria to the data retrieved through the use of filter 108, such as removing data attributable to internal callers (internal users) testing the speech recognition system. In this way, data to be transcribed can be filtered prior to transcription into meaningful groups with associated general characteristics for later transcription.

Once the data has been created and filtered, the transcription process begins. Because the present cross-platform transcription system is web-based, transcriptionists may transcribe data from any location having a suitable connection to the data. Data may be accessed over a network using an Internet protocol, such as hypertext Transfer Protocol (HTTP). HTTP is an application-level protocol for distributed, collaborative, hypermedia information systems. In one embodiment, the network used is a Virtual Private Network (VPN). A VPN uses privacy features such as encryption and tunneling to connect users or sites over a public network, typically the Internet. In comparison, a private network uses dedicated lines between each point on the network. As described in more detail below, a transcriptionist first initiates a connection to the database through a web browser, signs into the transcription system, chooses the records to be transcribed, and then begins the transcription process.

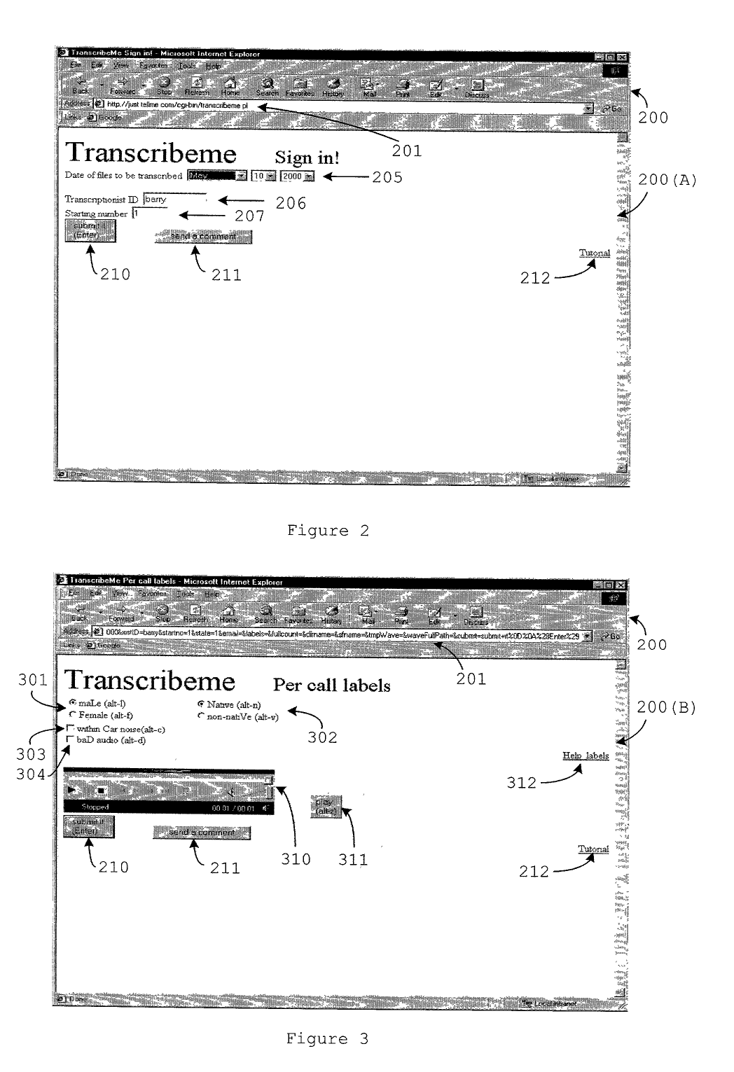

FIG. 2 is a screen shot of a sign-in screen for a transcription system according to one embodiment of the present invention. Web browser 200 (e.g. the Internet Explorer® web browser) displays the address (i.e. location) of the transcription system in address window 201. Web browser 200 displays sign-in screen 200(A). Within sign-in screen 200(A), the transcriptionist chooses a date of files to transcribe (field 205), enters a unique transcriptionist ID (field 206), enters a record starting number (field 207), and submits the above information by pressing submit button 210. A record is a collection of utterances during one interface with the speech recognition system (i.e. during one call). Comments may be sent to the system administrators by pressing comment button 211, and a tutorial describing the transcription system may be reached by clicking on tutorial hyperlink 212. In one embodiment, comments may also be stored with the transcribed utterances. Pressing submit button 210 causes the per-call-labels screen (FIG. 3) to appear within the web browser window.

Some embodiments may offer more sophisticated utterance selection mechanisms in conjunction with sign in to support more selective transcription in response to specific needs. For example, if “driving directions” was introduced as a new application, it might be possible to easily select only “driving direction”-related utterances for transcription. In other embodiments, the transcriptionist may not be directly presented with the utterance selection options, e.g., they may be predetermined for a transcriptions based on her/his login. In this embodiment, one or more supervisors and/or automated processes might automatically select utterances for a particular transcriptionist according to one or more criteria. Also, as will become clearer when discussed below, typically most, or all, of the available utterances for a particular call are transcribed in a single session by a single transcriber. This maximizes the value of the transcriber's natural language capabilities (especially if the transcriber is familiar with the application) and increases accuracy. However, this is not a technical requirement.

FIG. 3 is a screen shot of a per-call-labels screen according to one embodiment of the present invention. Web browser 200 navigates the browser window to the address shown in address window 201 in response to pressing submit button 210 in sign-in screen 200(A). Thus, a per-call-labels labels screen 200(B) is shown subsequent to sign-in screen 200(A), but prior to each record being transcribed. A series of utterances made during one call to the speech recognition system are likely to share certain characteristics: gender of user, whether user is a native or non-native speaker, car background noise, and overall bad audio quality. By allowing entry of these consistent labels once, labels that are typically consistent throughout a call need only be entered once. As described below, these per-call-labels are then filled in to the transcription screen for each related utterance to be transcribed (i.e. consistent labels are “sticky”), thereby speeding the transcription of each utterance.

In one embodiment, the short recording of the first utterance assigned to the first record is automatically played upon initial display of per-call-labels screen 200(B). Audio control panel 310 allows the transcriptionist to play the utterance, as well as perform other audio operations such as change the volume and pause the replay of the recording. Once the transcriptionist hears the utterance, per-call-labels 301-304 may be defined. Thus, the user's gender (either male or female) is defined using gender radio button 301 and the user's accent (either native or non-native) is defined using accent radio button 302. A radio button is a device that allows the selection of only one of a group of options (e.g. only one of “male” or “female” may be chosen in radio button 301). Similarly, noise within a car while a user is speaking on a cellular telephone may be noted by checking car noise checkbox 303 and bad audio signal may be noted by checking bad audio checkbox 304. A checkbox is a toggle device that allows a value to be set on (box is checked) or off (box is unchecked). Thus, an unchecked box indicates that the associated attribute is not present in the current utterance (or record). Note that keyboard shortcuts (hot keys) are available for radio buttons 301 and 302 as well as for checkboxes 303 and 304.

Note that transcriptionists make educated estimates for some of these values. For example, a transcriptionist may identify a particular utterance with a “female” label by using radio button 301. This transcription label does not mean that the user was in fact a woman, but rather means that the transcriptionist believes the caller to be a female. Throughout the transcription process as described below, the per-call labels may be adjusted as appropriate.

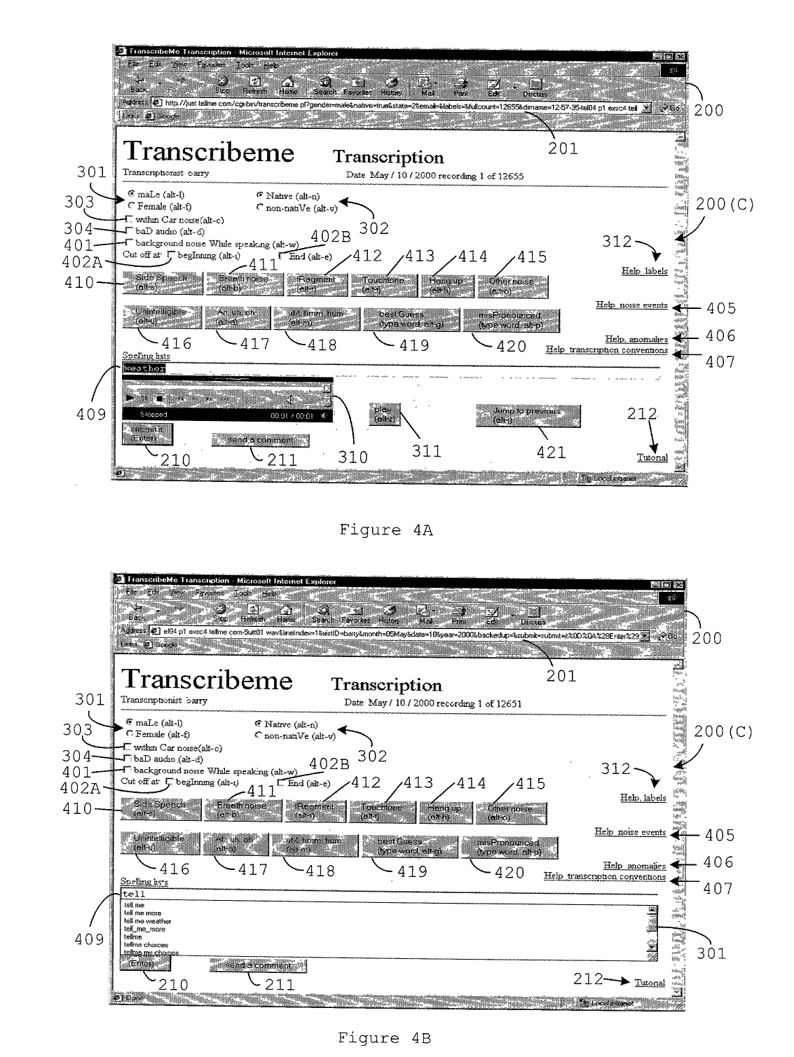

Similarly to sign-in screen 200(A), comments may be entered by pressing comment button 211, and a tutorial describing the transcription system may be reached by clicking on tutorial hyperlink 212. Additionally, help on labels may be reached by clicking on “help: labels” hyperlink 312. Pressing submit button 210 causes the transcription system to accept the per-call-labels information and then causes the transcription screen (FIG. 4A) to appear within the web browser window.

FIG. 4A is a screen shot of a transcription screen according to one embodiment of the present invention. Web browser 200 navigates a browser window to the address shown in address window 201 in response to pressing submit button 210 in per-call-labels screen 200(B). A transcription screen similar to transcription screen 200(C) is shown for each utterance in a record.

The short recording of the utterance to be transcribed is automatically played upon display of transcription screen 200(C). Text entry field 409 is automatically populated with the result of the speech recognizer. If the result of the speech recognizer is correct and no additional labels need be defined, the transcriptionist need only hit “Enter” on the keyboard (the keyboard short cut for submit button 210) to accept the transcription and move onto the next utterance to be transcribed. If the transcriptionist disagrees with the automatically populated text, the transcriptionist types the text translation of the utterance into text entry field 409 in place of the automatically populated text and adds any needed labels. Text entry field 409 is discussed in more detail with respect to FIG. 4B below. Note that previous button 421 allows the transcriptionist to return to the transcription screens of previously transcribed utterances.

In addition to transcribing the utterance, the transcriptionist provides labels describing the utterance sound recording. Per-call-labels 301-304, which were pre-populated from information from per-call-labels screen 200(B), are available for alteration in transcription screen 200(C). During one call, a first user may hand the telephone to a second user of a different gender or accent, necessitating a change in one of these “sticky” fields or the first user may move from a house to a car, etc. Additionally, checkboxes are provided for noting such events as background noise during the utterance (background noise checkbox 401) and whether the utterance recording is truncated either at the beginning (beginning cut off checkbox 402A) or at the end (end cut off checkbox 402B).

Noise events buttons 410-415 generate labeling text denoting an utterance directed other than towards the speech recognizer (side speech button 410), breath noise (breath noise button 411), a word fragment (fragment button 412), a DTMF touchtone noise (touchtone button 413), the sound of a hang up (hang up button 414), or other noise (other noise button 415). For example, pressing side speech button 410 generates the label “[side_speech]” and then inserts that label into text entry box 409 (not shown). Help is available for these noise events by clicking on “help: noise events” hyperlink 405.

Anomalies buttons 416-420 insert labeling text into text entry box 409 denoting anomalous utterances, including unintelligible utterances (unintelligible button 416), interjections such as “ah”, “uh”, or “oh” (ah, uh, oh button 417), and filler noises such as “um”, “hmm”, and “hum” (um, hmm, hum button 418). Anomalous utterances also include those transcriptions which are the best guess of the transcriptionist (best guess button 419) and which are the correct spelling of a mispronounced word (mispronounced button 420). For example, pressing mispronounced button 420 encases the transcribed word in asterisks within text entry box 409 (not shown). Although labels for anomalies are typically nonstandard across transcription systems, the consistent use of one type of label for each type of anomaly allows the possibility of a global label replacement to meet the requirements of a particular reporting system or analysis framework. Help is available for these anomalous utterances by clicking on “help: anomalies” hyperlink 406. Help is available for these transcription conventions by clicking on “help: transcription conventions” hyperlink 407. Note that most buttons, radio buttons, and checkboxes have keyboard shortcuts, thereby allowing the transcriptionist to perform most transcription functions without moving hands away from the keyboard.

FIG. 4B is another screen shot of the transcription screen 200(C) according to one embodiment of the present invention. As described above, text entry field 409 is pre-populated with the result of the speech recognizer. If the transcriptionist disagrees with the automatically populated text, the transcriptionist types the text translation of the utterance into text entry field 409 in place of the automatically populated text. As the transcriptionist types in text entry field 409, drop-down selection menu 409A (a part of text entry field 409) appears containing a list of possible words typed by the transcriptionist. As shown, the typed letters “t-e-l-l” produces a list of words beginning with those letters, such as “tell me” and “tell me more”. The auto-complete function of web browser 200 may be used to auto-complete the text typed by the transcriptionist with the most frequently used word having the same root letters. Note that drop-down selection menu 409A obscures audio tool 310, play button 311, jump button 421, and a portion of submit button 210 from view within transcription screen 200(C) (see FIG. 4A). Once a word is chosen for text entry box 409, drop-down selection menu 409A disappears. In one embodiment, only predetermined characters are allowable. In this embodiment, inserting a character not allowed (e.g. illegal punctuation or a numerical digit) in text box 409 triggers a warning to the transcriptionist that the character is not allowed for the transcription scheme.

Additionally, if supported by web browser 200, the transcriptionist may tab to select each element in turn (e.g. side speech button 410, then breath noise button 411). The transcriptionist may hit the “Enter” key on the keyboard as a short cut to perform the action associated with the highlighted element, thereby allowing the transcriptionist to additionally access most displayed elements without removing hands from the keyboard.

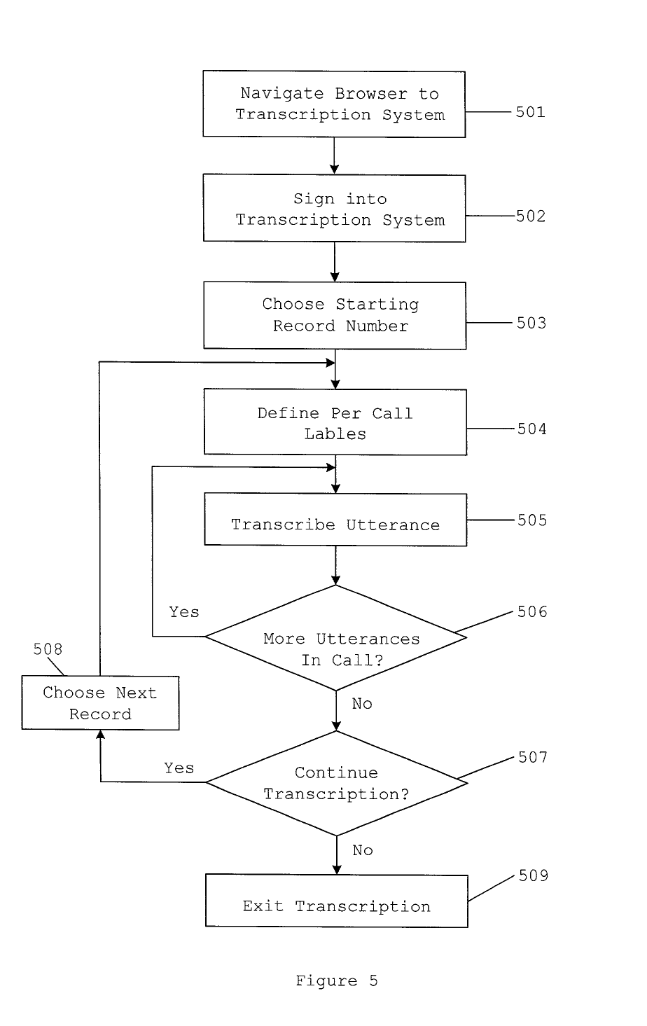

FIG. 5 is a flow diagram of the transcription process according to one embodiment of the present invention. As described above, a web browser is navigated to the address of the transcription system in step 501. Each transcriptionist signs into the transcription system in step 502 and chooses a starting record number. Steps 502 and 503 are performed using sign-in screen 200(A) (FIG. 2). Other embodiments of the transcription process include additional steps, such as a transcriptionist verification screen, wherein each transcriptionist verifies authorized access (e.g. uses a password to sign into the transcription system). As noted above with respect to FIG. 2, a transcriptionist may be transcribing a subset of a call, e.g., all utterances in “driving directions”, etc. However, for convenience the term “call” will be used since in the preferred embodiment, a transcriptionist only works on utterances taken from a single phone call at a time.

Additionally, in one embodiment, the utterances from a given call are transcribed in sequence. Because calls navigate through a defined set of menus with defined grammars, transcribing the calls in sequence gives the transcriptionist additional context, thereby improving the transcription accuracy. For example, an utterance such as “San Jose, Calif.” might be difficult to recognize out of context, but may be easier to recognize if the previous utterance was “weather”, thereby indicating the desire to obtain weather information including the forecast for a particular city.

Once a starting record is chosen in step 503, per-call-labels are defined in step 504 using per-call-labels screen 200(B) (FIG. 3). The first utterance is transcribed in step 505 using transcription screen 200(C). If additional utterances are present in the record (step 506), the additional utterances are transcribed returning to transcribe utterance step 505. If no more utterances are present in the record, a decision is made by the transcriptionist whether or not to continue transcribing records in step 507. In one embodiment, the transcriptionist initially chooses a certain number of records to transcribe, thereby automating “continue transcription?” step 507.

If the transcription is to continue with another record in step 507, the next record is selected in step 508 and per-call-labels defined for that record in step 504. If the transcription is finished, the transcription system is exited in step 509.

In one embodiment, the transcribed information extends the tuple stored in the database to include an additional data element indicating the transcribed value. For example, after transcription, the tuple contains the elements (date/time, grammar then in use, result, parameters, pointer to stored utterance recording, transcribed result).

It is important for all of this transcription data to be available for analysis in a meaningful, yet easy to understand fashion. Accordingly, the present invention provides for a system of drill-down reports to describe the transcription data. These drill-down reports include data compilation into a top-level analysis with direct hyperlinked access to supporting data. As described below, this system of drill-down reports allows all relevant information to be compiled according to a constructed query (date range, selected grammars, selected calls, etc.) for purposes such as double-checking transcription accuracy, application assessment, or insufficiently clear guides on responses within a given grammar. Statistical and heuristic analysis of the transcribed results compared to the results of the speech recognizer in the context of the grammar allow grammar authors and application programmers to determine if the menu prompting options are sufficient to guide a user through the menu as well as determining whether the grammar and/or the pronunciation should be tuned to be more consistent with typical menu use. For example, if a certain pronunciation of a given word in a grammar is consistently marked as mispronounced, the grammar author might consider tuning the pronunciation dictionary for the speech recognition software to include that pronunciation of the word.

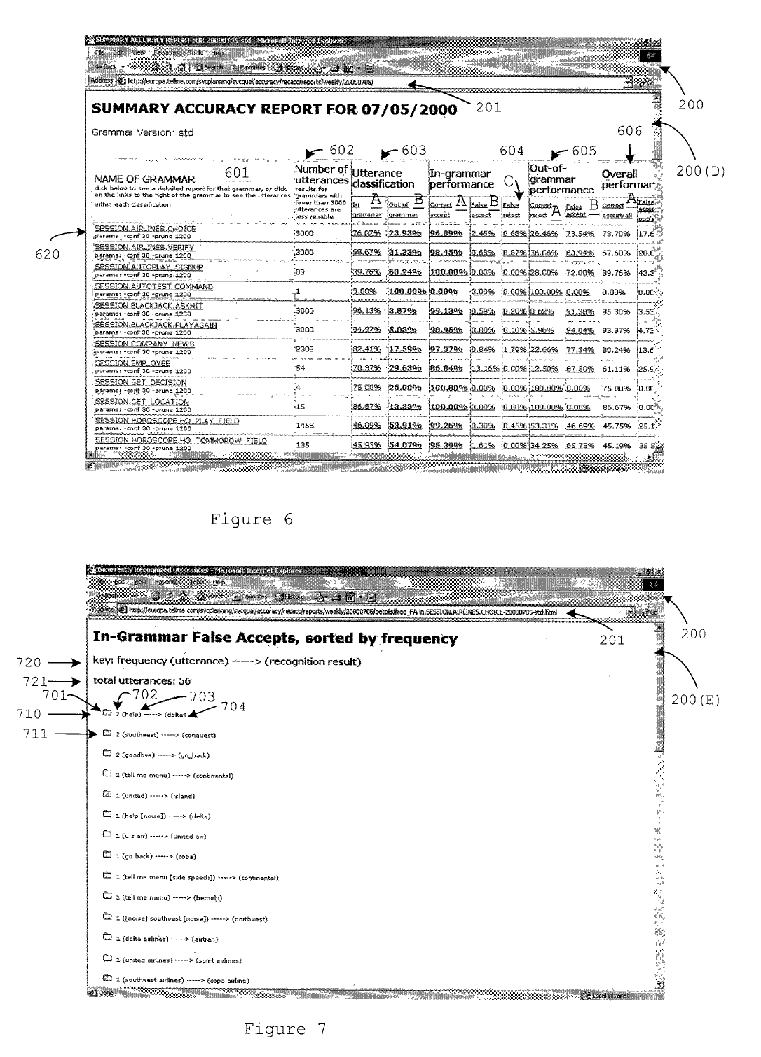

FIG. 6 is a screen shot of a top-level drill-down report according to one embodiment of the present invention. Thus, web browser 200 navigates the browser window to the address shown in address window 201 when choosing the drill-down report feature of the present transcription system. For example, a summary accuracy report for a given date, shown in report screen 200(D), is shown prior to each record to be transcribed. Data in report screen 200(D) is organized into a table format, wherein each column represents a type of top-level data relevant for a top-level analysis of the accuracy of the speech recognition system and each row represents a different grammar. For example, columns 602-606 include top-level data for the number of utterances 602, classification of utterance 603, in-grammar performance 604, out-of-grammar performance 605, and overall performance 606 data summaries for each corresponding grammar in name of grammar column 601.

Specifically, in a telephone information service having a menu which connects users to an airline of their choice, the grammar for that menu includes the name of each airline in the service. Thus, the grammar-in-use includes airline names, such as “delta”, “southwest”, and “united”. The grammar-in-use additionally includes words in applicable intrinsic grammars, such as “help” and “go back”. The Session.Airlines.Choice grammar, located in row 620 of accuracy report window 200(D), is the grammar for such a telephone information service. As shown, 3000 utterances have been transcribed (row 620, column 602) relating to the Session.Airlines.Choice grammar. These utterances have been analyzed to provide the data present in row 620, columns 603-606. Thus, of those 3000 utterances, 76.07% are in-grammar (column 603A) and 23.93% are out-of-grammar (column 603B), where “out-of-grammar” indicates that the utterance was not one of the valid words within the Session.Airlines.Choice grammar used for the telephone information service.

Of the 76.07% in-grammar utterances (column 603A), the speech recognizer correctly interpreted 96.89% (column 604A), falsely accepted 0.66% (column 604B), and falsely rejected 0.66% (column 604C). A false acceptance occurs when the utterance is out-of-grammar, yet the speech recognizer interprets the utterance as in-grammar. A false rejection occurs when the utterance is in-grammar, yet the speech recognizer interprets the utterance as out-of-grammar. The comparison is made between the transcribed utterance and the word recognized by the speech recognizer, such that the percentage of correctly interpreted utterances is equivalent to the number of in-grammar utterances interpreted by the speech recognizer that match the corresponding transcribed utterance divided by the in-grammar number of utterances.

Of the 23.93% out-of-grammar utterances (column 603B), the speech recognizer correctly rejected 26.46% (column 605A) and falsely accepted 73.54% (column 605B). The overall performance of the speech recognizer for the Session.Airlines.Choice grammar is described in column 604, with the percentage of correct acceptances divided by all utterances, and is equal to 73.70% (column 606A).

Each grammar in accuracy report screen 200(D) has similar top-level information. Note that additional top-level information may be added to accuracy report screen 200(D) by adding to the number of columns. Additional information is available for this top-level by clicking on the associated hyperlink. For example, the Session.Airlines.Choice grammar is underlined. In a web-based system, this underline (and typically an associated color) indicates a hyperlink. In one embodiment, clicking on the Session.Airlines.Choice grammar hyperlink navigates web browser 200 to another web page displaying the valid words in-grammar for the Session.Airlines.Choice grammar. In another embodiment, clicking on the Session.Airlines.Choice grammar hyperlink opens an additional web browser in which the web browser screen displays the valid words in-grammar for the Session.Airlines.Choice grammar. Support data for the data in columns 603-606 are similarly accessed.

FIG. 7 is a screen shot of a first-level-down drill-down report according to one embodiment of the present invention. Clicking on the 2.45% false accepts for in-grammar performance (row 620, column 604B, of FIG. 6) navigates web browser 200 to in-grammar false accepts screen 200(E). Thus, web browser 200 navigates the browser window to the address shown in address window 201 when choosing the 2.45% false accepts for in-grammar performance (row 620, column 604B, of FIG. 6) in the present transcription system. Data in in-grammar false accepts screen 200(E) is organized into a file system format, wherein each row includes a folder icon (e.g. folder 701, which in one embodiment is itself a hyperlink), an number indicating the frequency of a particular type of false accept (for example number 702), the transcribed utterance (for example transcribed utterance 703), and the result of the speech recognizer (for example result 704). Key 720 describes the format for naming these in-grammar false accepts. Specifically, in row 710, the speech recognizer mistook the in-grammar utterance “help” (transcribed utterance 703) for the word “delta” (result 704) seven times (number 701). Similarly, in row 711, the speech recognizer mistook the in-grammar utterance “southwest” for the word “conquest” twice.

Note that the number of in-grammar utterances for the Session.Airlines.Choice grammar is the number of utterances (3000 in row 620, column 602, in FIG. 6) multiplied by the percent of utterances in-grammar (76.07% in row 620, column 603A, in FIG. 6), which is equivalent to 2286 in-grammar utterances. The number of false accepts of these in-grammar utterances is 2.45% (row 620, column 604B, FIG. 6) multiplied by 2286 in-grammar utterances, which is equivalent to 56 in-grammar false accepts. This number of in-grammar false accepts is listed in line 721 of in-grammar false accepts screen 200(E).

Additional information is available for this first-level-down information by clicking on the associated folder hyperlinks. Clicking on the folder 701 hyperlink (row 710) opens a sub-list of the seven (number 702) in-grammar help-delta false accepts. Specifically, in one embodiment, clicking on the folder 701 hyperlink alters in-grammar false accepts screen 200(E) to include hyperlinks to “.wav”, or “WAV format”, files 801-807 as shown in FIG. 8. Hyperlinks to .wav files 801-807 are indented under folder 701 to show that they are the seven utterance recordings of the in-grammar utterance “help” which were recognized as “delta” by the speech recognizer. Support data for the data in row 711 (and other rows) is similarly accessed.

In one embodiment, clicking on a hyperlink to one of .wav files 801-807 (e.g. .wav file 801) navigates web browser 200 to another web page displaying the utterance, result, and a sound tool for playing the utterance. In another embodiment, clicking on a hyperlink to one of .wav files 801-807 (e.g. .wav file 801) opens an additional web browser in which the web browser screen displays the utterance, result, and a sound tool for playing the utterance.

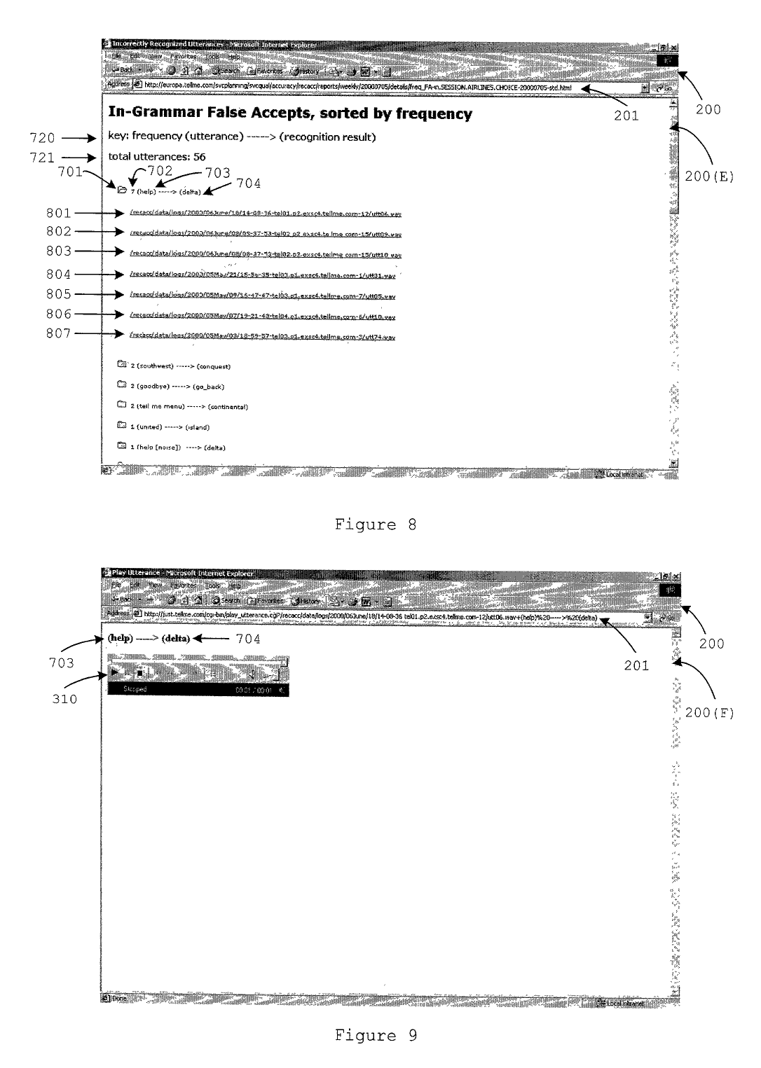

FIG. 9 is a screen shot of a third-level-down drill-down report according to one embodiment of the present invention. Clicking on the hyperlink for .wav file 801 navigates web browser 200 to wav file screen 200(F) displaying transcribed utterance 703 (e.g. “help”), result 704 (e.g. “delta”), and a sound tool 310 for playing the utterance audio. As described with respect to the transcription process, audio control panel 310 allows the utterance audio to be played, as well as other audio operations to be performed, such as changing the volume and pausing the replay of the recording.

In this way, both top-level data and low level data can be easily displayed and quickly obtained. For example, a specific sound file included in the performance analysis of in-grammar false accepts can be accessed in three clicks from the top-level description of performance.

Other Embodiments

In one embodiment, the transcription tools and accuracy reports are made available as part of a zero-footprint remotely hosted development environment. See, U.S. patent application Ser. No. 09/592,241, entitled “Method and Apparatus for Zero-Footprint Application Development”, having inventors Jeff C. Kunins, et. al., filed Jun. 13, 2000. In such configuration, the transcriptionist will frequently be the application developer or her/his authorized agent. Additionally, utterance access will be limited to those utterances made within the developer's own application(s). For example, if the application was accessed by a user through “Shopping”, “Bookstore”, only the utterances for grammars within the “Bookstore” menu item would be available to the developer for transcription.

In one embodiment, the transcription and accuracy tools are a separately paid for component of the zero-footprint development environment. In another embodiment, the developer can specifically request that the hosting sites (e.g. the hosting site 101) record utterances for her/his application(s). In some embodiments, there may be a charge for this service.

In another embodiment, developers can request transcription of a predetermined number of utterances, e.g., 10,000, from the provider of the zero-footprint development environment (or their affiliates, etc.) for a cost. Then the developer can simply use the accuracy reports without the need for her/him to perform the transcriptions.

The embodiments described above are illustrative only and not limiting. For example, in other embodiments of the invention, additional steps such as secured login and data encryption may be added to the transcription process. Moreover, data may be displayed in any form that clearly conveys meaningful information during report generation. Other embodiments and modifications to the system and method of the present invention will be apparent to those skilled in the art. Therefore, the present invention is limited only by the appended claims.

1. A method of transcription using a web-based server, the method comprising:
receiving a first request over a network, the first request corresponding to a request to transcribe an utterance;
accessing a set of one or more tuples in response to the first request; and
receiving a second request, the second request corresponding to a human provided transcription of an utterance.

2. The method of claim 1, wherein the first request is generated by a standard web browser.

3. The method of claim 1, wherein the network is the Internet.

4. The method of claim 1, wherein the network is a Virtual Private Network (VPN).

5. The method of claim 1, wherein the network uses an Internet protocol.

6. The method of claim 5, wherein the Internet protocol is Hypertext Transfer Protocol (HTTP).

7. The method of claim 1, wherein each tuple includes:
the utterance;
a grammar-in-use during the utterance; and
a recognized result of a speech recognizer of the utterance.

8. The method of claim 7, wherein the tuple is extended to include the human provided transcription of the utterance.

9. The method of claim 1, wherein the set of one or more tuples is aggregated from a larger set of tuples using a first selection criteria.

10. The method of claim 9, wherein aggregation from a larger set of utterance tuples further uses a second selection criteria.

11. The method of claim 9, wherein a first transcriptionist accesses the set of one or more tuples.

12. The method of claim 11, wherein a second transcriptionist accesses a subset of tuples aggregated from the larger set of tuples using the first selection criteria, the set of one or more tuples and the subset of tuples having mutually exclusive tuples.

13. The method of claim 1, wherein the transcription of the utterance includes:
playing an audio definition of the utterance;
defining a text translation of the utterance;
labeling the text translation with audio attributes of the utterance;
labeling the text translation with characterizations of the utterance if present; and
labeling the text translation with utterance anomalies if present.

14. A web-based transcription system, comprising:
a set of one or more stored utterance tuples, each tuple including:
an utterance,
a grammar-in-use during the utterance, and
a recognized result of a speech recognizer from the utterance;
an access system for accessing the set of tuples, the access system including:
a sign-in portion for identifying a transcriptionist and for identifying a subset of the set of tuples,
a persistent label portion for identifying labels consistent across each related portion of the subset of tuples,
a transcription portion for transcribing the utterance associated with each tuple in the subset of tuples; and
an extension system for extending each tuple in the subset of tuples to include the transcribed utterance.

15. The system of claim 14, the access system further including a noise events portion for adding transcription labels to the transcribed utterance defining types of the utterance.

16. The system of claim 14, the access system further including an anomalies portion for adding transcription labels to the transcribed utterance defining qualities of the utterance.

17. The system of claim 14, the access system further including an audio tool for playing the utterance.

18. The system of claim 14, the persistent label portion further including keyboard shortcuts for identifying labels.

19. The system of claim 14, the transcription portion further comprising an auto-complete function for automatically completing a portion of the transcribed utterance.

20. The system of claim 19, the transcription portion further comprising a commonly transcribed utterance list including commonly transcribed utterances beginning with the portion of the transcribed utterance.

21. The system of claim 14, the access system including an information portion for accessing additional information on a portion of the access system.

22. The system of claim 21, wherein the information portion is a help portion and the additional information is help information.

23. A web-based transcription system, comprising:
a set of one or more stored utterance tuples, each tuple including:
an utterance,
a grammar-in-use during the utterance, and
a recognized result of a speech recognizer from the utterance;
means for accessing the set of tuples, including:
a sign-in portion for identifying a transcriptionist and for identifying a subset of the set of tuples,
a persistent label portion for identifying labels consistent across each related portion of the subset of tuples,
a transcription portion for transcribing the utterance associated with each tuple in the subset of tuples; and
means for extending each tuple in the subset of tuples to include the transcribed utterance.

24. The system of claim 23, the transcription portion including a noise events portion for adding transcription labels to the transcribed utterance defining types of the utterance.

25. The system of claim 23, the transcription portion further including an anomalies portion for adding transcription notation to the transcribed utterance defining qualities of the utterance.

26. The system of claim 23, means for accessing further including an audio tool for playing the utterance.

27. The system of claim 23, the persistent label portion further including keyboard shortcuts for identifying labels.

28. The system of claim 23, the transcription portion further comprising an auto-complete function for automatically completing a portion of the transcribed utterance.

29. The system of claim 28, the transcription portion further comprising a commonly transcribed utterance list including commonly transcribed utterances beginning with the portion of the transcribed utterance.

30. The system of claim 23, means for accessing including an information portion for accessing additional information on a portion of the access system.

31. The system of claim 30, wherein the information portion is a help portion and the additional information is help information.

32. A method of drill-down reporting using a web-based system, the method comprising:
defining a first filter criteria;
accessing a set of one or more stored utterance tuples meeting the first filter criteria, each tuple including:
an utterance,
a grammar-in-use during the utterance,
a recognized result of a speech recognizer from the utterance, and
a transcribed utterance;
providing analysis of the set of tuples in a first standard form of reporting, the first standard form of reporting including internal linking to a first set of support data associated with the set of tuples.

33. The method of claim 32, wherein the set of tuples is aggregated from a larger group of tuples.

34. The method of claim 32, wherein the first filter criteria are defined from user constructed queries.

35. The method of claim 32, the method further comprising tuning of the grammar-in-use in response to the analysis of the set of tuples.

36. The method of claim 32, the method further comprising tuning of a pronunciation of the grammar-in-use in response to the analysis of the set of tuples.

37. A web-based drill-down reporting system, the system comprising:
means for defining a first filter criteria;
means for accessing a set of one or more stored utterance tuples meeting the first filter criteria, each tuple including:
an utterance,
a grammar-in-use during the utterance,
a recognized result of a speech recognizer from the utterance, and
a transcribed utterance;
means for providing analysis of the set of tuples in a first standard form of reporting, the first standard form of reporting including internal linking to a first set of support data associated with the set of tuples.

38. The system of claim 37, wherein the set of tuples is aggregated from a larger group of tuples.

39. The system of claim 37, wherein the first filter criteria are defined from user constructed queries.

40. The system of claim 37, the method further comprising means for tuning of the grammar-in-use in response to the analysis of the set of tuples.

41. The system of claim 37, the method further comprising means for tuning of a pronunciation of the grammar-in-use in response to the analysis of the set of tuples.

42. A web-based drill-down reporting system, the system comprising:
a first filter criteria;
a set of one or more stored utterance tuples meeting the first filter criteria, each tuple including:
an utterance,
a grammar-in-use during the utterance,
a recognized result of a speech recognizer from the utterance, and
a transcribed utterance;
means for generating analysis of the set of tuples in a first standard form of reporting, the first standard form of reporting including internal linking to a first set of support data associated with the set of tuples.

43. The system of claim 42, wherein the set of tuples is aggregated from a larger group of tuples.

44. The system of claim 42, wherein the first filter criteria are defined from user constructed queries.

45. The system of claim 42, the method further comprising means for tuning of the grammar-in-use in response to the analysis of the set of tuples.

46. The system of claim 42, the method further comprising means for tuning of a pronunciation of the grammar-in-use in response to the analysis of the set of tuples.

47. A web server system comprising:
a central processing unit;
a memory unit; and
a network interface for sending a message, the message enabling a display screen to display:
a set of buttons defining audio characteristics, and
an audio tool for playing an audio file.

48. The server system of claim 47, the display screen further enabled to display a submit button for accepting the audio characteristics defined by the set of buttons into a data file.

49. The server system of claim 47, the display screen further enabled to display a text entry box for entering a transcription of the audio file.

50. The server system of claim 49, the display screen further enabled to display a drop-down list of possible text entries for entering into the text entry box.

51. The server system of claim 49, wherein the text entry box is pre-populated with a text entry provided by a speech recognizer.

52. The server system of claim 49, wherein the text entry box is pre-populated with a text entry from a data file associated with the audio file.

53. The server system of claim 47, wherein the set of buttons includes a button defining a gender of a speaker of the audio file.

54. The server system of claim 47, wherein the set of buttons includes a button defining an accent of a speaker of the audio file.

55. The server system of claim 47, wherein the set of buttons includes a button defining a quality of the audio characteristics.

56. The server system of claim 55, wherein the quality is background noise.

57. The server system of claim 55, wherein the quality is noise within a car.

58. The server system of claim 55, wherein the quality is audio information missing at a beginning of the audio file.

59. The server system of claim 55, wherein the quality is audio information missing at an end of the audio file.

60. The server system of claim 55, wherein the quality is side speech.

61. The server system of claim 55, wherein the quality is breath noise.

62. The server system of claim 55, wherein the quality is a sentence fragment.

63. The server system of claim 55, wherein the quality is a touchtone noise.

64. The server system of claim 55, wherein the quality is a hang up noise.

65. The server system of claim 55, wherein the quality is unintelligible speech.

66. The server system of claim 55, wherein the quality is filler speech.

67. The server system of claim 55, wherein the quality is mispronounced speech.

68. The server system of claim 47, the display screen further enabled to display a help tool for providing help for items displayed on the display screen.

69. The server system of claim 68, the help tool providing help for one or more of the set of buttons.

70. The server system of claim 47, the display screen further enabled to display a tutorial tool for providing training information for the server system.

71. A web server system comprising:
a central processing unit;
a memory unit; and
a network interface for sending a message, the message enabling a display screen to display:
a grammar, the grammar including an associated link to more information about the grammar, and
an utterance classification associated with the grammar including:
an in-grammar portion defining utterances included in the associated grammar, the in-grammar portion including an associated link to more information about the in-grammar portion, and
an out-of-grammar portion defining utterances outside the associated grammar, the out-of-grammar portion including an associated link to more information about the out-of-grammar portion.

72. The server system of claim 71, wherein the links to more information cause the display screen to display additional information about the associated portions.

73. The server system of claim 70, wherein the additional information is more detailed information about the associated portion.

74. The server system of claim 73, wherein the more detailed information includes associated links to further detailed information about the associated portion.

75. The server system of claim 74, wherein the further detailed information is support data.

76. The server system of claim 74, wherein the further detailed information is one or more audio files.

77. The server system of claim 71, wherein the link to more information about the in-grammar portion causes the display screen to display more detailed information about the in-grammar portion.

78. The server system of claim 77, wherein the more detailed information includes links to further detailed information about the in-grammar portion.

79. The server system of claim 71, the display screen further displaying an in-grammar performance associated with the grammar including:
a correctly accepted portion defining utterances correctly accepted by a speech recognizer, the correctly accepted portion including a link to more information about the correctly accepted portion;
a falsely accepted portion defining utterances incorrectly accepted by the speech recognizer, the falsely accepted portion including a link to more information about the falsely accepted portion; and
a falsely rejected portion defining utterances incorrectly rejected by the speech recognizer, the falsely rejected portion including a link to more information about the falsely rejected portion.

80. The server system of claim 71, the display screen further displaying an out-of-grammar performance associated with the grammar including:
a correctly rejected portion defining utterances correctly rejected by a speech recognizer, the correctly rejected portion including a link to more information about the correctly rejected portion; and
a falsely accepted portion defining utterances incorrectly accepted by the speech recognizer, the falsely accepted portion including a link to more information about the falsely accepted portion.

81. The server system of claim 71, the display screen further displaying an overall performance associated with the grammar including:
a correctly rejected portion defining utterances correctly rejected by a speech recognizer, the correctly rejected portion including a link to more information about the correctly rejected portion; and
a falsely accepted portion defining utterances incorrectly accepted by the speech recognizer, the falsely accepted portion including a link to more information about the falsely accepted portion.
